(19) United States
(12) Patent Application Publication
(10) Pub. No.: US 2004/0215827 A1
(43) Pub. Date: Oct. 28, 2004

(54) Address sequencing in a domain name server

(75) Inventors: Christophe Preguica, Massy (FR); Nicolas Rebierre, Massy (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/787,145

(22) Filed: Feb. 27, 2004

(30) Foreign Application Priority Data
Feb. 28, 2003 (FR) 03 02 443

(51) Int. Cl. G06F 15/16; G06F 7/00

(52) U.S. Cl. 709/245; 709/203; 707/10

(57) ABSTRACT

A domain name server (DNS) associated with a data network, including means for the reception of requests R containing a domain name and the means to return to the sender of the request a response containing one or more addresses associated with the domain name, characterised in that the addresses are sequenced within the response by the domain name server.

This invention relates to telecommunication networks, and in particular those using the IPv6 (Internet Protocol, version 6) protocol stack. More precisely, it concerns the resolution of addresses in a domain name server associated with such telecommunication networks.

Such domain name servers are well known in the state of the art, and are conventionally known as Domain Name Servers or DNS. The operation of the DNS is standardised and described in RFCs 1034 and 1035 of the IETF (Internet Engineering Task Force).

The purpose of domain name servers is to simplify addressing within an IP telecommunication network. They behave like telephone directories, associating the symbolic names of network elements (or domain names), which represent no reality in the network, with the numerical addresses of these network elements.

Thus, when a first network element wants to address a data stream to a second network element, it can use either the address of this second network element, if it is known, or the symbolic name of this second element.

In this latter case, the first network address element sends a request containing this symbolic name to the domain name server. In return, it receives the numerical address or addresses corresponding to this symbolic name. It can also send the data stream to the second network element using its address.

However, a problem arises when a single domain name is associated with several addresses. This is the case in particular in a network employing the IPv6 protocol stack, where the IPv6 specifications actually allow the association of several addresses with a single network element.

The use of a DNS system in an IPv6 type network is described in RFC 1886 of the IEFF, entitled “DNS Extensions to Support IP Version 6”.

These addresses can be addresses of different levels. As described in RFC 2373 of the IEFF, entitled “IP version 6 Addressing Architecture”, there exist different types of address, differentiated on the basis of a prefix. There are therefore addresses with a global value, and addresses with a local value, particularly local to a site. When the sender and the recipient of the data stream are located in a single addressing space (a site), it is best to use a local address proper to this addressing space. This type of address local to a site will later be referred to also as a site address.

In any other case, the global address should be used, because otherwise the data stream cannot be correctly routed to the recipient.

If the global address is always used, then the data streams will be routed correctly, but use of the network will not be optimal. Moreover, no guarantee is given regarding whether the data streams will ever leave the site.

It is possible to have addresses of different natures, like an IPv6 address and one known as a “6to4” address, for example, as described by RFC 3056 of the IETF, entitled “Connection of IP Domains via IPv4 Clouds”.

This is one of the mechanisms used for the gradual migration of an IPv4 type network to an IPv6 type network.

The “6to4” mechanism allows purely IPv6 network elements to communicate with other IPv6 network elements via purely IPv4 network elements. In order to achieve this, a particular type of addresses, known as “6to4 addresses”, is defined. The addresses of this type are recognisable by the network elements because they begin with the prefix “2002”. Thus on receipt of a packet bearing such an address, a network element at the edge of the IPv6 site is able to encapsulate it in an IPv4 packet so that it can get it to its destination.

Use of the wrong address could lead to receipt of an IPv6 address by a network element which is compatible with IPv4 only, or indeed to an unacceptable limitation of the addressing space. The result would be failure to route the data stream.

In these two situations, a single name is associated with several addresses. The domain name server therefore sends all of these addresses as its response to a request, and the network element which has sent the request arbitrarily uses any of these addresses.

Now in the first situation, the use of an inappropriate address is not optimal from the network viewpoint.

Furthermore, in the second situation, the use of an inappropriate address may not allow correct addressing of the network element one wishes to reach.

There exist solutions which consist of sequencing the addresses, or indeed of assigning choices of different addresses according to certain criteria, but these solutions consist of performing the choosing or the sorting at the level of the applications. Such solutions are described, for example, in the document entitled “draft-ieft-ipngwg-default-addr-select-05.txt” dated 4 Jun. 2001.

However, such a solution overloads the applications and, by allowing them too much freedom, can give rise to incorrect behaviour patterns in the whole of the communication network. In addition, an application may not have sufficient sight of the network in order to enable it to choose the optimum address. Finally, such a solution does not allow the deployment of an overall network management policy.

The aim of the invention is to overcome the drawbacks of the current state of the art, by allowing the network element sending out a data stream to use the most effective and optimum address.

To this end, the subject of the invention is a domain name server associated with a data network, which include:

means for receiving requests containing a domain name, and

means for returning a response, containing one or more addresses associated with a domain name, to the sender of the request.

According to the invention, this domain name server is characterised in that this address, or these addresses, are sequenced by the domain name server inside the response.

According to one embodiment of the invention, this sequencing is effected as a function of the content of the request.

Sequencing can also be effected according to the topology of the network, where the most local address allowing one to address both the said sender of the request, and the network element corresponding to the domain name, is inserted first.

Sequencing can also be effected so that in the event of the presence of an IPv4 cloud between the sender of the requests and the network element corresponding to the domain name, and address of the “6to4” type is inserted first.

The invention and its advantages will appear more clearly in the description which follows below, together with the appended figures:

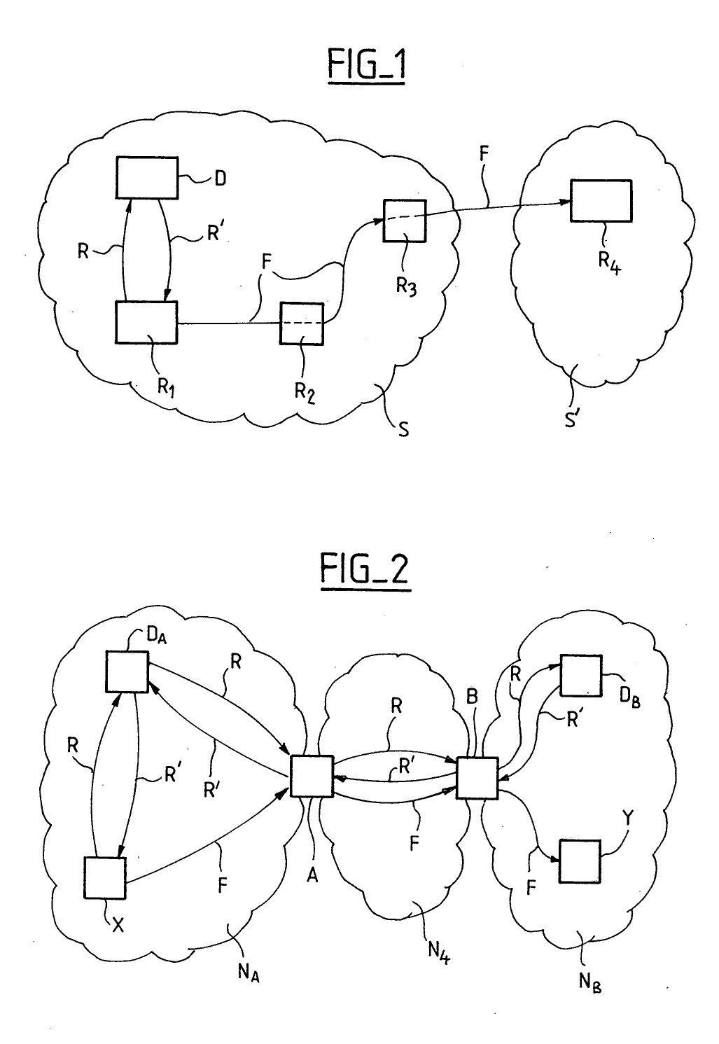

FIG. 1 illustrates a first implementation of the invention.

FIG. 2 represents a second implementation of the invention.

FIG. 1 illustrates a network element composed of two sites (S and S′). Site S contains network elements R₁, R₂ and R₃, and site S′ contains network element R₄.

As mentioned previously, there are different types of IPv6 addresses, which can be distinguished by different prefixes.

Among these address types, there are site-local addresses (or site addresses) and global addresses.

A site-local address is recognised because it is of the form “FEC0::/10”, which means that the first 10 bits have the value FEC0 and the following 118 represent the addressing space proper. Similarly, a local link address is recognised because it is of the form “FE80::/80”.

As a result, network element R₄, for example, can have a global address a_{g} and a site-local address aₛ. This global address a_{g} can be like that defined in RFC 2374, entitled “An IPv6 aggregatable Global Unicast Address”. This allows network element R₄ to enter into communication with network elements located at other sites, such as, for example, network element R₁ located at site S.

Let us assume that network element R₁ wants to transmit a data stream to network element R₄.

To this end, it sends a request R to domain name server D, containing the symbolic name or domain name of network element R₄.

According to the invention, domain name server D is able to sequence the different addresses of the wanted network element in the response provided to the sender of the request R.

To this end, it can use information contained in this request R. Among this information, in particular, is the source address of the request, that is the address of network element R₁. Knowing the addresses of network elements R₁ and R₄, as well as the topology of the network, the domain name server is then able to determine the type of address to be used. In the present example, it is able to determine that network elements R₁ and R₄ are not located at the same site, and therefore that the local address must not be used.

Disregarding other possible addresses, the server D therefore sequences the addresses in the order a_{g} aₛ in the response R′ which it is sending to network element R₁.

On receipt of this response R′, network element R₁ is able to determine the address to use by selecting the first in the sequence, namely address a_{g}. It can then use address a_{g} to insert as the destination address in the data stream packets F which it is transmitting to network element R₄.

Without this sequencing, performed by the domain name server D, network element R₁ would have no means of determining the address that it must use. It might then have used the local address a which would have led, in this case, to failure to route the data stream F.

In other words, the sequencing performed by the domain name server D is effected as a function of the request. If the source address of the request is a local address, and if the name requested has a local address, it is the local address which will be sent first.

In general, what is involved is inserting the most local address in the first position, thereby enabling the addressing of both the sender (here network element R₁) of request R and the network element corresponding to the wanted domain name (here network element R₄).

If network element R₁ wishes to transmit a data stream to network element R₃, the domain name server sends its site-local address first (if it exists), so that network element R₁ can use this in its communications with R₃.

FIG. 2 illustrates a second implementation of the invention in the context of a heterogeneous network composed of IPv4 network elements and IPv6 or IPv4/IPv6 network elements.

Various mechanisms exist. In this example, the “6to4” mechanism is used. However, the invention is designed to apply to different mechanisms from the moment when different addresses are necessary.

In this example, a data network is composed of two domains N_{A} and N_{B} separated by a cloud N₄, composed only of IPv6 network elements. This example illustrates the normal case of two sites which have migrated to the IPv4 technology, and which are connected via a third network by a telecommunication operator, not yet having migrated and still compatible only with the IPv4 protocols.

Network elements A and B are routers connecting cloud N₄ to domains N_{A} and N_{B} respectively.

In each of the domains, N_{A} and N_{B}, we have a domain name server (or DNS), D_{A} and D_{B} respectively. It is assumed that the two servers, D_{A} and D_{B}, are suitably configured, and mutually possess their correct address.

In a first stage, the sending network element x, wanting to transmit a data stream to a recipient network element Y, located in domain N_{B}, sends a request R to domain name server D_{A} associated with domain N_{A}. This request R contains the symbolic name of the recipient Y, and contains a source address which is an address of the sender x.

On receipt of this request R, server D_{A} determines whether it possesses an association between the symbolic name contained in the request and an address. Since the recipient is outside domain N_{A} “controlled” by server D_{A}, this association does not appear in the tables or in the database of server D_{A}. According to a recursive configuration, it transmits the request to the domain name server D_{B} of domain N_{B}.

Since the recipient Y and the server D_{B} form part of the same domain N_{B}, the latter possesses the information relating to the recipient Y and to the association of its (symbolic) domain name and its addresses. In this example, the recipient Y possesses at least two addresses:

an a_{V6} address which conforms to the IPv6 protocol which allows network element Y to communicate with the other network elements of domain Y or with network elements of other IPv6 domains (not shown),

an a₆ₜₒ₄ address which conforms to the “6to4” technology mentioned previously, allowing the communication of two IPv6 network elements via an IPv4 cloud.

According to the invention, domain name server D_{B} sequences the two (or more) addresses corresponding to the symbolic name of the wanted network element Y.

Sequencing can be effected as a function of the content of the request transmitted by domain name server D_{A}. In fact this request contains the address of the sender (domain name server D_{A}), which allows domain name server D_{B} to determine that since the source address is one of the “6to4” type, then “6to4” technology should be used.

It is therefore able to determine that the relevant address is the a₆ₜₒ₄ address of the recipient Y, and as a consequence, it is able to sequence the various addresses by putting the most relevant address a₆ₜₒ₄ (the “6to4” address of recipient Y) first, and inserting these sequenced addresses in a response R′.

This response is then sent to domain name server D_{A}, which is then able to respond to the request from the sender x.

According to the invention, this sender is capable of interpreting the sequence of addresses in the response R′. This interpretation can consist of simply using the first address contained in the response. This first address is the A₆ₜₒ₄ address, which is compatible with the “6to4” mechanism.

The sending network element x can the use the a₆ₜₒ₄ address to address the data stream to the recipient network element Y. This data stream F will traverse network elements A and B and cloud N₄, being routed correctly.

In other words, the sequencing performed by the domain name server D_{B} is effected in such a manner that in the case of the presence of an IPv4 cloud (here N₄) between the sender of the request (here X) and the network element corresponding to the domain name contained in the request (here Y), and address of the “6to4” type (here a₆ₜₒ₄) is inserted first.

It is as a result of this sequencing effected by the domain name server D_{B} that the sending network element x is able to determine the a₆ₜₒ₄ address to be used.

1) A domain name server (DNS), associated with a database, having means to receive requests \mathring{R} containing a domain name, and the means to return to the sender of the said request, a response containing one or more addresses associated with the said domain name, characterised in that the said address or addresses are sequenced within the said response by the said domain name server.

2) A domain name server according to claim 1, in which the sequencing is effected at least as a function of the content of the said request.

3) A domain name server according to claim 2, in which the sequencing is in addition effected as a function of the topology of the network, where the most local address, used to address both the said sender of the request and the network element corresponding to the said domain name, is inserted first.

4) A domain name server according to claim 3, in which the sequencing is effected in such a manner that in the case of the presence of an IPv4 cloud (here N₄) between the said sender of the request and the network element corresponding to the said domain name, an address of the “6to4” type is inserted first (here a₆ₜₒ₄).
